(19) United States
(12) Patent Application Publication
(10) Pub. No.: US 2009/0048959 A1
(43) Pub. Date: Feb. 19, 2009

(54) SHARE MAP DISPLAY APPARATUS, SHARE MAP DISPLAY SYSTEM, AND PROGRAM FOR THE SAME

(76) Inventors: Kei Omura, Tokyo (JP); Noboru Shinohara, Tokyo (JP); Naohito Doi, Tokyo (JP); Yoshimori Rikukawa, Tokyo (JP)

Correspondence Address: STAAS & HALSEY LLP, SUITE 700, 1201 NEW YORK AVENUE, N.W., WASHINGTON, DC, 20005, US

(21) Appl. No.: 12/294,569

(22) PCT Filed: Mar. 29, 2006
(86) PCT No.: PCT/JP2006/306514

§ 371 Date: Sep. 25, 2008

(51) Int. Cl. G06Q 40/00; G06F 17/00

(52) U.S. Cl. 705/35; 715/234; 715/246

(57) ABSTRACT

Information on the handling records and occupancy status such as of a company carrying financial products in the financial capital market is converted into image data the contents of which can be visually sensibly grasped. A display region forming section (14) of a share map display apparatus (1) has a first display region indicating the total amount of the handling records of specific financial product. Generally the whole part of the first display region is divided into generally rectangular second display regions whose areas are determined according to the information on the handling records in a specific field out of the specific financial product. Generally the whole part of each second display region is divided into generally rectangular third display regions whose areas are determined according to the handling records of the financial institution in the specific field, thus forming display regions of a hierarchical structure. The second display regions inside the first display region and the third display regions inside the second display region are arranged in order of area from the upper left corner down to the lower right corner. The ratio of the record of the current period to that of the previous period is indicated with a color tone. The image data is converted into data of HTML format and sent to a Web browser.

### CROSS REFERENCE TO RELATED APPLICATIONS

This application claims the benefit under 35 U.S.C. Section 371, of PCT International Application No. PCT/JP2006/306514, filed Mar. 29, 2006, the disclosures of which are hereby incorporated by reference.

### TECHNICAL FIELD

The present invention relates to a technology for forming image data and displaying the same on a computer interface, more precisely, to a technology for forming and displaying the image data concerning the occupancy status in the financial capital market of a company which deals with financial products.

### BACKGROUND OF THE INVENTION

To the investors, professional traders such as financial companies, securities companies etc., or to the companies raising and selling marketable securities such as stocks, bonds etc. or dealing with financial transactions such as MA, loan and investment (herein after these capital market participants are called “investors”), information related to an occupancy status in the market and a total amount of handling records (which include lead management, underwriting, intermediation, bond management etc.) of financial products and transactions handled by financial organizations (banks, securities companies etc.) who mainly deal with financial products is a matter of high concern. Specifically, information on each company's occupancy status of a specific financial product in the financial and capital market and information on the handling records of financial products handled by the company that plays a role to coordinate financial organizations that take up stocks or bonds to be issued by a listing company and bear highest sharing of responsibility (herein after called as a “lead manager” in the present invention as a representative appellation) are important information in making decision when the investors open an account or in selecting one financial organization as a lead manager when the companies offer their stocks to the public or issue bonds.

In a conventional art, there has been known a technology to provide the investors and the professionals with information in making decision by displaying information on the handling records of financial products of the financial organization on the display of a computer terminal (for example Patent Document 1: Japanese Patent Publication 2005-100148 A). On the other hand, a technology for visualizing information of financial products in the form of a graphic area etc. has been proposed (for example, Patent Document 2: U.S. Pat. No. 6,583,794 B).

### DISCLOSURE OF THE INVENTION

### Problems to be Solved

However, in the Patent Document 1, gain and loss and their causes at the time when every financial transaction was performed, are displayed on separate screens in a multiple tabular forms or line graphs. For example, comparative consideration of various information such as handling record of various companies in the same financial-product field is difficult to be performed based on the information displayed on the screens.

In the Patent Document 2, the image displayed on the computer interface is an information on a market capitalization etc. of each company (FIGS. 2A to 4), not directly related to the handling records of the financial organization.

In the technology shown in the Patent Documents 1 and 2, the image data displayed on a computer interface are merely binary data which is actually difficult to display directly on the client's terminal etc. of the client server system through the network. And in a case where such data are displayed on a screen of a client's terminal, images in some cases, can not be displayed unless browsing software (for example “Java” (registered trademark) applet) is booted up together with the Web browser, raising security concerns at the client's terminal and causing additional work to be done in system management at the client side terminal.

In addition, in the Patent Document 2, there is no regularity in the arrangement and in the size of graphics displayed on a computer screen, so it is difficult to figure out the relationship between the graphics, rank them in order and determine relative merits between them based only on the graphics displayed on the screen.

The present invention was made in consideration of the above-mentioned problems. An object of the present invention is to provide a share map display apparatus and share map display system to provide information useful for the investors in making decision by forming and displaying image data, which is easily visualized and interpreted, and is easy to be formed into image data that can be conveyed through the network and to be displayed on a computer interface.

### Means to Solve the Problems

In order to solve the problems mentioned above, the first aspect of the present invention is a share map display apparatus which displays on displaying means of a terminal, an information on an occupancy status of a company such as a financial institution which deals with financial product in a financial capital market, has display region forming means which forms:
a first display region having a certain shape and indicating a total amount of handling records of a specific financial product;
a plurality of second display regions each having a rectangular shape, an area of which is determined based on an information on the handling records of the specific financial product in a specific field, a whole area of the first display region is divided into the plurality of second display regions, and
a plurality of third display regions each having a rectangular shape, an area of which is determined based on each handling record that constitutes the specific field, a whole area of the second display region is divided into the plurality of third display regions,
wherein the display region forming means forms at least 3 hierarchically-structured display region groups, the second display region is a lower hierarchy of the first display region which is divided into the plurality of second display regions, the third display region is a lower hierarchy of the second display region which is divided into the plurality of third display regions, and the display region forming means arranges the plurality of second display regions inside the first display region and the plurality of third display regions inside the second display region in a descending order of area from an upper left corner down to a lower right corner, respectively.

A second aspect of the present invention is that in addition to the first aspect, the share map display apparatus further has image data forming means for converting the display region groups into data of HTML format and sending the HTML formatted data to the display means of the terminal.

A third aspect of the present invention is that in addition to the first aspect, wherein the display region forming means arranges the second display region and the third display region into a shape as close as possible to a square shape.

A fourth aspect of the present invention is that in addition to the third aspect, the display region forming means repeatedly rearranges all of the second display regions inside the first display region so that the arranged second display region has a shape as close as possible to a square shape by:
at first, calculating a ratio of each area to a total area of the second display regions;
based on the calculated ratio, marking off an area at an upper left portion of the first display region, which is not yet occupied by any one of the second display regions, in proportion to the ratio of one or a plurality of second display regions having the largest area/larger areas out of all second display regions by either vertical or horizontal straight line; and then marking off an inside, which is already marked off, of the first display region in proportion to the ratio of one or a plurality of the second display regions by either vertical or horizontal straight line.

A fifth aspect of the present invention is that in addition to the third aspect, the display region forming means repeatedly rearranges all of the third display regions inside the second display region so that the arranged third display region has a shape as close as possible to a square shape by:
at first, calculating a ratio of each area to a total area of the third display regions;
based on the calculated ratio, marking off an area at an upper left portion of the second display region, which is not yet occupied by any one of the third display regions, in proportion to the ratio of one or a plurality of third display regions having the largest area/larger areas out of all the third display regions by either vertical or horizontal straight line; and then marking off an inside, which is already marked off, of the second display region in proportion to the ratio of one or a plurality of the third display regions by either vertical or horizontal straight line.

A sixth aspect of the present invention is that in addition to the first aspect, the display region forming means determines the area of an individual third display region based on the handling records of a financial product in the specific field of a company that handles individual financial product.

A seventh aspect of the present invention is that in addition to the first aspect, the display region forming means determines the area of the second display region based on the information on the total amount of the handling records of the financial product in the specific field.

An eighth aspect of the present invention is that in addition to the first aspect, the share map display apparatus further has record comparison display means that performs following steps:
aggregating information on the handling records for every prescribed time period;
comparing information on the handling records for a specific time period with information on the handling records for the period right before the specific time period; and
displaying a change in the information on the handling records calculated by the comparison on the third display region.

A ninth aspect of the present invention is that in addition to the eighth aspect, the record comparison display means displays the change in the information on the handling records by color and density of the color on the third display region.

A tenth aspect of the present invention is that in addition to the first aspect, the information on the handling records is an information on an issued amount of a financial product handled by a company that handles the financial product as a lead manager.

An eleventh aspect of the present invention is a share map display system, which comprises:
a share map display apparatus according to claim 1; and
a database for storing data, including information on the handling records of a specific financial product, of a finance event, an act at a specific time point for changing funds or capital of an organization such as a firm.

A twelfth aspect of the present invention is a program for making a computer function as a share map display apparatus according to claim 1.

### EFFECTS OF THE INVENTION

According to the first aspect of the present invention, a share map display apparatus has display region forming means which arranges:
a first display region having a certain shape and indicating a total amount of handling records of a specific financial product;
a plurality of second display regions each having a rectangular shape, an area of which is determined based on an information on the amount of the handling records of the specific financial product in a specific field, a whole area of the first display region is divided into the plurality of second display regions, and
a plurality of third display regions each having a rectangular shape, the area of which is determined based on each handling record that constitutes the specific field, a whole area of the second display region is divided into the plurality of the third display regions,
   wherein the display region forming means forms at least 3 hierarchically-structured display region groups, the second display region is a lower hierarchy of the first display region which is divided into the plurality of second display regions, the third display region is a lower hierarchy of the second display region which is divided into the plurality of third display regions. Therefore, the handling records i.e. a transaction amount, total transaction amount of a financial product in a specific field and the handling records i.e. handling amount of a financial product of an individual company which handles financial product in a specific field, can visually be grasped as areas of repeated hierarchically structured display regions. The display region forming means arranges the plurality of second display regions inside the first display region and the plurality of third display regions inside the second display region in descending order of an area from an upper left corner down to a lower right corner, respectively. Therefore, the magnitude of ratio of an individual area of the second or third display region to the total area of the second or third display regions can easily be grasped visually. That is, the handling records and occupancy status of financial products in the market can easily be grasped visually. Accordingly, the information on the handling records and occupancy status of financial products in the market is converted into an easy-to-visually-understand able image data capable to be communicated through the network and can be displayed on the computer interface, being able to provide more useful information to the investors etc.

According to the second aspect of the present invention, the share map display apparatus further has image data forming means for converting the display region groups into data of HTML format and sending them to the display means of the terminal. Therefore at the terminal side, the data can be displayed by using only the web server and with no degradation in response time. Accordingly, information on the handling records and occupancy status of financial products in the market is converted into an easy-to-visually-understand able image data capable to be communicated through the network and can be displayed on the computer interface, being able to provide more useful information to the investors etc.

According to the third aspect of the present invention, the display region forming means arranges the second display region and the third display region into a shape as close as possible to a square shape. Accordingly, easy-to-be-readable character data can be displayed inside the second and the third display regions. Therefore, the contents of the information in the individual region can be easily displayed by character data so that concrete contents of information on the handling records of financial products of a company can be grasped more visually, being able to provide more useful information to the investors etc.

According to the fourth aspect of the present invention, the display region forming means repeatedly rearranges all of the second display regions inside the first display region so that the arranged second display region has a shape as close as possible to a square shape by:
at first, calculating a ratio of each area to a total area of the second display regions;
based on the calculated ratio, marking off an area of an upper left portion of the first display region, which is not yet occupied by any one of the second display regions, in proportion to the ratio of one or a plurality of second display regions having the largest area/larger areas out of all the second display regions by either vertical or horizontal straight line; and then marking off an inside, which is already marked off, of the first display region in proportion to the ratio of one or a plurality of the second display regions by either vertical or horizontal straight line. Therefore, the second display regions can easily and surely be arranged into a shape as close as possible to a square shape and be arranged generally in the descending order of area from an upper left corner down to a lower right corner using a computer algorithm. Accordingly, concrete contents of more useful information on the handling records of financial products of a company can visually be provided to the investors etc.

According to the fifth aspect of the present invention, the display region forming means repeatedly rearranges all of the third display regions inside the second display region so that the arranged third display region has a shape as close as possible to a square shape by:
at first, calculating a ratio of each area to a total area of the third display regions;
based on the calculated ratio, marking off an area at an upper left portion of the second display region, which is not yet occupied by any one of the third display regions, in proportion to the ratio of one or a plurality of third display regions having the largest area/larger areas out of all the third display regions by either vertical or horizontal straight line; and then marking off an inside, which is already marked off, of the second display region in proportion to the ratio of one or a plurality of the third display regions by either vertical or horizontal straight line. Therefore, the third display regions can easily and surely be arranged into a shape as close as possible to a square shape and be arranged generally in the descending order of area from an upper left corner down to a lower right corner using a computer algorithm. Accordingly, concrete contents of more useful information on the handling records of financial products of a company can visually be provided to the investors etc.

According to the sixth aspect of the present invention, the display region forming means determines the area of an individual third display region based on the handling records of a financial product in the specific field of a company that handles individual financial product. Therefore, the handling record of a financial product of a company etc., ranking of handling record of the financial product of individual company in a specific financial capital market and the occupancy status in the market can easily be grasped visually, being able to provide more useful information to the investors etc.

According to the seventh aspect of the present invention, the display region forming means determines the area of the second display region based on the information on the total amount of the handling records of the financial product in the specific field. Therefore, ranking and occupancy status of individual financial product (for example, the domestic public bond SB, publicly-offered local bond, government-backed bond etc. which constitutes amount of domestic public issue) in the total amount of a financial product (for example, the amount of issue of domestic public bond) in a specific field can easily be grasped visually, being able to provide more useful information to the investors etc.

According to the eighth aspect of the present invention, the share map display apparatus further has record comparison display means that performs following steps:
aggregating information on the handling records for every prescribed time period;
comparing information on the handling records for a specific time period with information on the handling records for the period right before the specific time period; and
displaying a change in the information on the handling records calculated by the comparison on the third display region. Accordingly, in addition to a relative relationship between various information shown by the third display regions, magnitude and direction of changes with time of individual information shown by the specific display region can also be grasped, being able to provide more useful information to the investors etc.

According to the ninth aspect of the present invention, the record comparison display means displays the change in the information on the handling records by color and density of the color on the third display region. Therefore, changes with time in the individual information displayed on the specific third display region can be visually grasped, being able to provide more useful information to the investors etc.

According to the tenth aspect of the present invention, information on the handling records is an information on an issued amount of a financial product handled by a company that handles the financial product as a lead manager. Therefore, important information such as information for making a decision at the time when the investors open an account or for selecting a securities company or financial institution which may be a lead manager at the time they offer their stocks to the public or issue bonds, can visually be displayed, being able to provide more useful information to the investors etc.

According to the eleventh aspect of the present invention, the share map display system, which comprises:
a share map display apparatus according to claim 1; and
a database for storing data, including information on the handling records of a specific financial product, of a finance event, an act at a specific time point for changing funds or capital of an organization such as a firm. Therefore, the share map display system having a database and a share map display apparatus can provide investors etc. with useful information.

According to the twelfth aspect of the present invention, the present invention can be programmed, so that the present invention can be utilized on various computer hardware.

### BRIEF DESCRIPTION OF THE DRAWING

FIG. 1 is a system and functional block diagram of a share map display system of an embodiment of the present invention.

FIG. 2A is an image diagram of a bond table stored in a finance database.

FIG. 2B is an image diagram of a bond table stored in a finance database.

FIG. 3A is an image diagram of a table of stocks to be dealt with, stored in the finance database.

FIG. 3B is an image diagram of a table of stocks to be dealt with, stored in the finance database.

FIG. 4 is a flow chart showing a processing procedure of the share map display system of the embodiment of the present invention.

FIG. 5 is a flow chart showing a concrete procedure of share map creation by the share map display system of the embodiment of the present invention.

FIG. 6A is a schematic diagram showing processing procedure in forming and arranging a display region which is performed in the share map display system of the embodiment of the present invention.

FIG. 6B is a schematic diagram showing processing procedure in forming and arranging a display region, which is performed in the share map display system of the embodiment of the present invention.

FIG. 7 is a schematic diagram of a process for determining a color tone used for a third display region, which is performed in the share map display system of the embodiment of the present invention.

FIG. 8 is an image diagram showing a whole share map displayed on a Web browser.

FIG. 9 is an image diagram showing a partial share map displayed on the Web browser.

FIG. 10 is an image diagram showing a detailed information display page displayed on the Web browser.

FIG. 11 is an image diagram showing a detailed-information display page of a financial institution displayed on the Web browser.

### BEST MODE FOR CARRYING OUT THE INVENTION

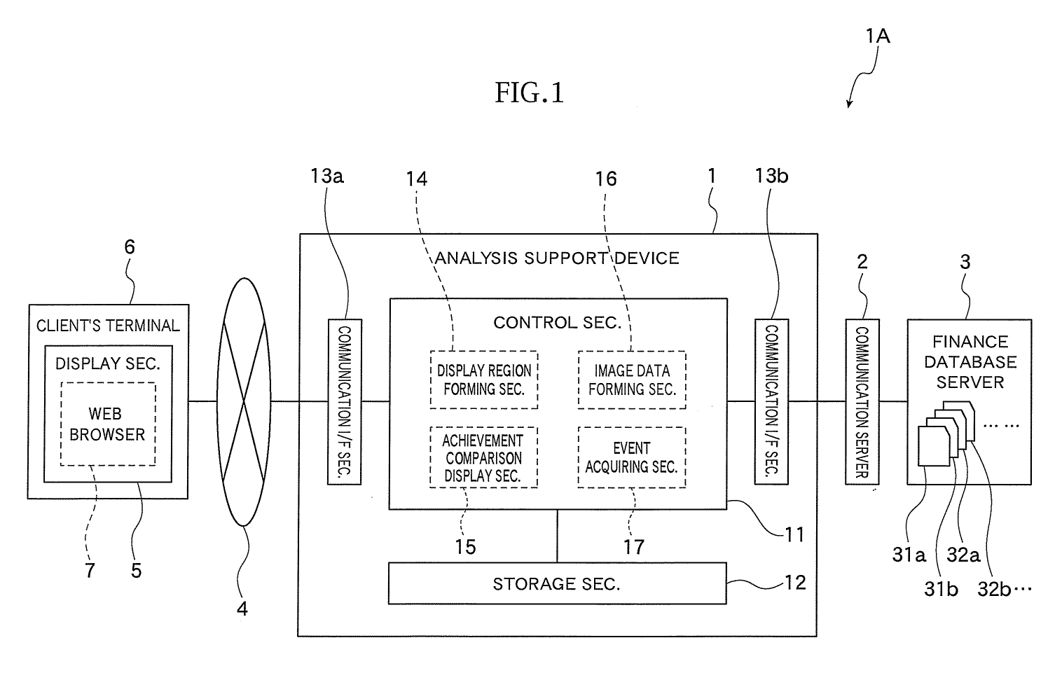

Embodiments of the present invention will be explained below with reference to FIGS. 1 to 11.

### Embodiment 1

FIG. 1 is a system and functional block diagram of a share map display system of an embodiment of the present invention. As shown in FIG. 1, the share map display system 1A has a share map display apparatus 1, a communication server 2, a finance database server (database) 3. The share map display apparatus 1 is connected to a client terminal (terminal) 6 having a display (display means) 5 through the internet 4.

The share map display apparatus 1 is a computer having a Web server function and as shown in FIG. 1 has a control section 11, a storing section 12 and a communication interface section (I/F section) 13a, 13b.

The control section 11 is provided with a CPU (Central Processing Unit) and arithmetically processes an OS (Operating System) program and various kinds of application programs stored in the storing section 12 to control a whole share map creation processes.

In the control section 11, a display region forming section (display region forming means) 14, a handling record comparison and display section (handling record comparison display means) 15, an image data forming section (image data forming means) 16 and an event acquiring section 17 are provided as functional means. These functional means become workable when an application program stored in the storing section 12 and the CPU etc. in the control section 11 are in cooperation with each other.

The display region forming section 14 forms a plurality of display region groups in the form of hierarchical structure and also arranges these display region groups inside a display region of an upper hierarchy based on the size of the areas thereof (how to form and arrange the display region groups will be described later).

The handling record comparison and display section 15 aggregates (adds up) information on the handling records for every prescribed time period, compares information on the handling record for a specific time period with the handling record for a period right before the specific time period, and displays a change in the information on the handling record (period-over-period basis), which is obtained as the result of the comparison on the display regions by color and density of the color (details will be explained later).

The image data forming section 16 converts the display region groups which is formed and arranged by the image region forming section 14, and the change of information of the handling records which is displayed on the display region group by the handling record comparison and display section 15 into data of HTML (Hyper Text Markup Language) format and send them to the display section 5 of the client's terminal 6.

The event acquiring section 17 acquires information of an event (which is in the present invention an event at a specific time such as a specific date etc.) of a firm's finance (which in the present invention is an act for changing funds or capital of an organization such as a firm etc.) stored in the finance database 3. In addition, the event acquiring section 17 acquires data of a record in each table of the finance database 3 as a unit. The corresponding relationship between a request from the client terminal 6 and a record group to be acquired is previously determined.

The storing section 12 comprises ROM on which a loading program etc. is previously stored, RAM on which the programs and data are temporarily stored and function as an operation region of the control section 11 (CPU), EEPROM which stores data to be rewritten and a hard disk which stores various file data etc. In the hard disc, the OS programs and various application programs are stored.

The communication interface section 13a, 13b is a UTP cable port, an optical cable port or various device drivers. The communication interface section 13a, 13b connects a LAN cable or an optical cable and performs processing necessary to perform the data communication between the communication server 2 and the client terminal 6.

The finance database server 3 has a large-capacity storage region (hard disc etc.) on which data of the financial events are stored (contents of data will be described later).

The communication server 2 is a Web server and performs processing necessary to send data from the finance database server 3 to the share map display apparatus 1 through LAN (Local Area Network).

The client terminal 6 is a terminal such as personal computers, personal digital assistants (PDA), mobile communication terminals such as cell-phone units etc. capable to perform data communications under the network environment. The display section 5 of the client terminal 6 is a LCD (Liquid Crystal Display) etc. and displays various image data etc. Software for Web browser is installed on the client terminal 6. On the display section 5, the Web browser 7 is displayed. The Web browser 7 performs data communication with the share map display apparatus 1 using HTTP (Hyper Text Transfer Protocol).

In the finance database 3, the finance event is stored as a table group of “product”. Here, “products” is a generic term used for the means to achieve a goal in a financial plan. For example, “products” corresponds to bonds/(common) stocks plan, classified stocks, share warrants etc. The table group of “products” is an aggregate of “entity” which is a data storage unit. For example, “entity” of “bond” is an individual bond itself. The table of “stock plan” is an individual plan itself for example, an issue of government bonds or stock splits.

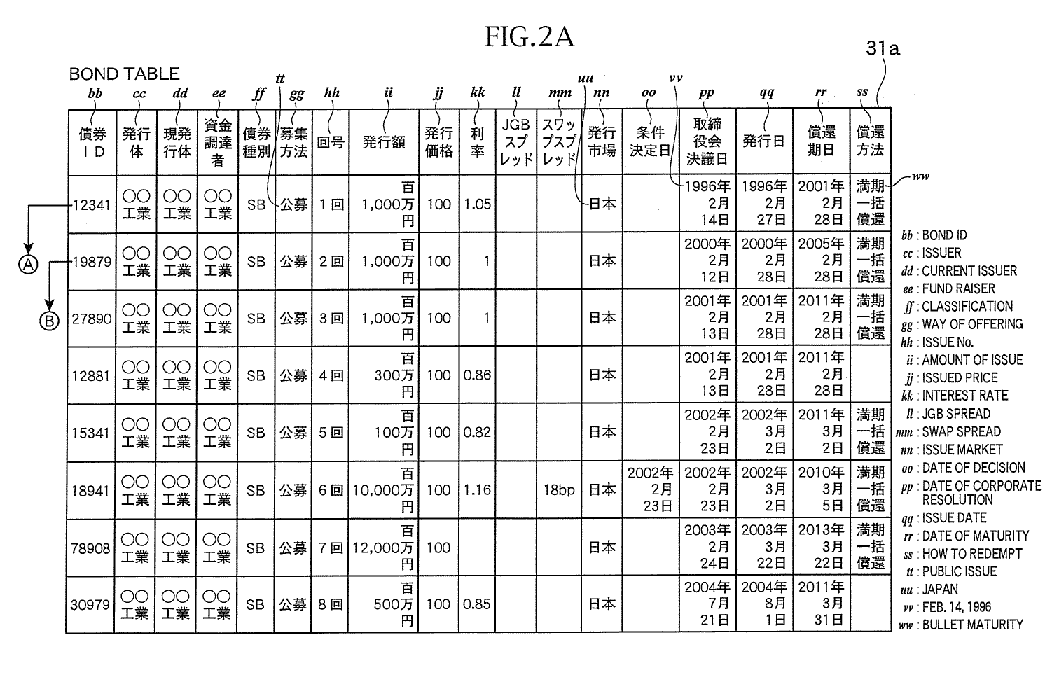

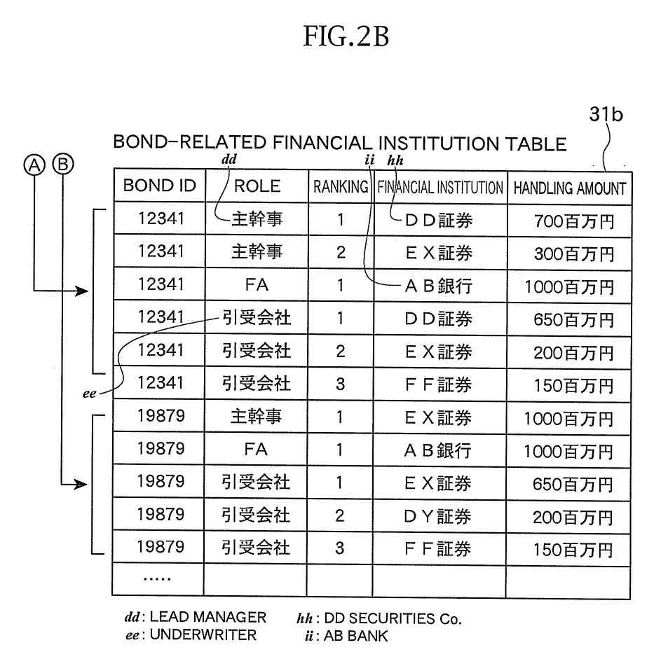

FIGS. 2A and 2B are image diagrams showing one bond table stored in the finance database 3. The bond table 31a, 31b illustrate data of one organization (OO industry Co. Ltd.), the bond issuer, as one of the examples. The bond table 31a (FIG. 2A) is provided with a bond-related financial institution table 31b (FIG. 2B) in which information related to the banks/securities companies which are involved in the issue of bonds is stored. One bond in the bond table is assigned with a code (illustrated by “bond ID”) by which the bond is identified individually. The corresponding relationship between one bond in the bond table and the information related to the bank/securities companies which are involved in the issue of bonds are directly correlated with each other because the same bond ID value is assigned on both records. For example, the first offering of SB public bond in the bond table (the first line of the bond table in FIG. 2A) is assigned a bond ID value of 12341 and information on bond related financial institution of the relevant bond corresponds to a line having a bond ID value of 12341 in the bond related financial institution table.

The bond table 31a and the bond related financial institution table 31b each has the number of columns which corresponds to the number of items recorded.

The recorded items of the bond table 31a includes bond ID, issuer, current issuer, funds raiser, bond type, way of offering, issuance number, amount of issue, issue price, interest rate, JGB spread, swap spread, issue market, condition decision date, corporate board resolution date, issue date, maturity date, redemption method (such items are shown in FIG. 2A), as well as issuance charges, total amount paid, total amount of funds raising, presence or absence of simultaneously-issued bond, asset back etc. (any of these items are not shown in FIG. 2A).

The bond ID, role, rank order, financial institution and amount of money (which are shown in FIG. 2B) are recorded in the bond-related financial institution table 31b.

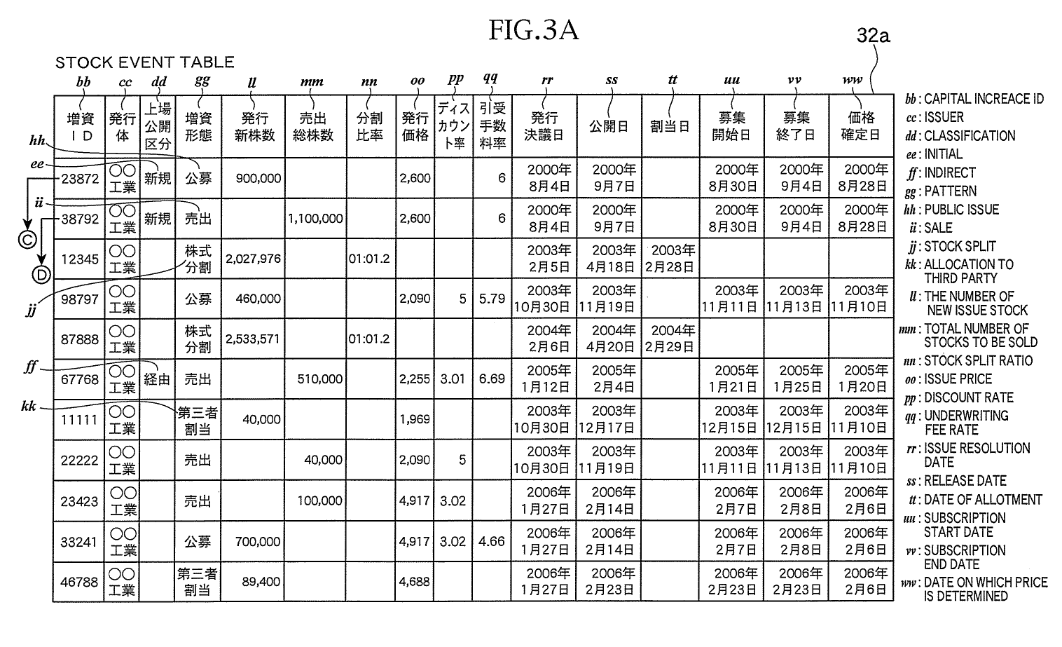

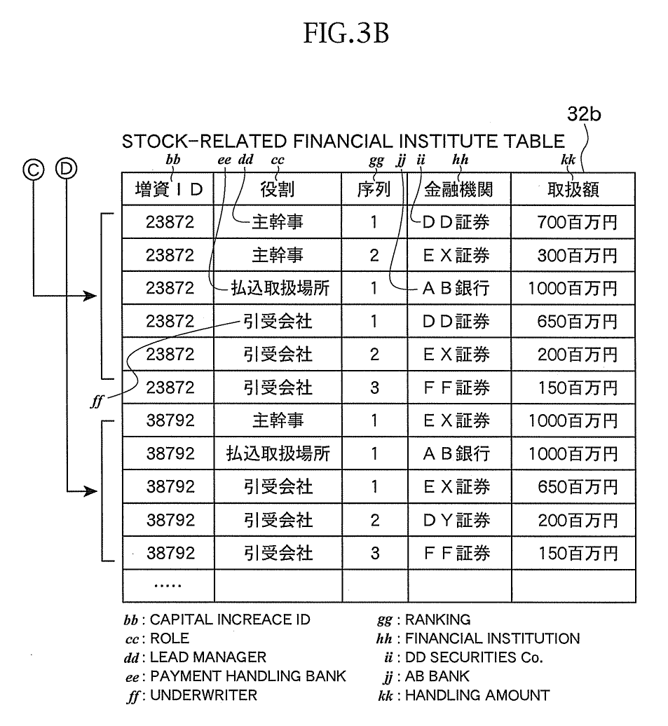

FIGS. 3A and 3B are image diagrams showing one of the stock investment table stored in the finance database 3. This stock investment table 32a, 32b illustrate data of one organization (OO Industry Co. Ltd.), a bond issuer, as one of the examples. The stock investment table 32a (FIG. 3A) is provided with a stock related financial institution table 32b (FIG. 3B) in which information on the banks/securities companies which are involved in the stock investment is stored. One investment in the stock investment table is assigned with a code (illustrated as “capital increase ID”) by which the investment is identified individually. The corresponding relationship between one investment in the stock investment table and information on the bank/securities companies which are involved in the investment in the stock related financial institution table is established because the same capital increase ID value is assigned on both records. For example, an initial public offering in the stock investment table of FIG. 3A (the first line of the stock investment table of FIG. 3A) is assigned a stock increase ID value of 23872 and information on the stock related financial institution of this relevant investment corresponds to a line having a stock increase ID value of 23872 in the stock related financial institution table.

The stock investment table 32a and the stock related financial institution table 32b each has the same number of columns corresponding to the number of recorded items.

The recorded items in the stock investment table 32a includes the stock increase ID, stock issuer, classification, capital increase, the number of issued new stock, the number of total offering stocks, stock split ratio, issue price, discount ratio, underwriting fee rate, issuance resolution date, release date, date of allotment, subscription starting date, subscription ending date, date on which price is determined (these items are shown in FIG. 3A), as well as kind of stock, nominal par, roughly estimating time, tentatively set price range determination date, price determination date, due date of payment, date for delivery, effective date, starting date for estimating demand, ending date for estimating demand, calculating formula deciding date (these items are not shown in FIG. 3A).

The stock increase ID number, role, rank order, financial institution and an amount of money (which are shown in FIG. 3B) are recorded in the stock-related financial institution table 32b.

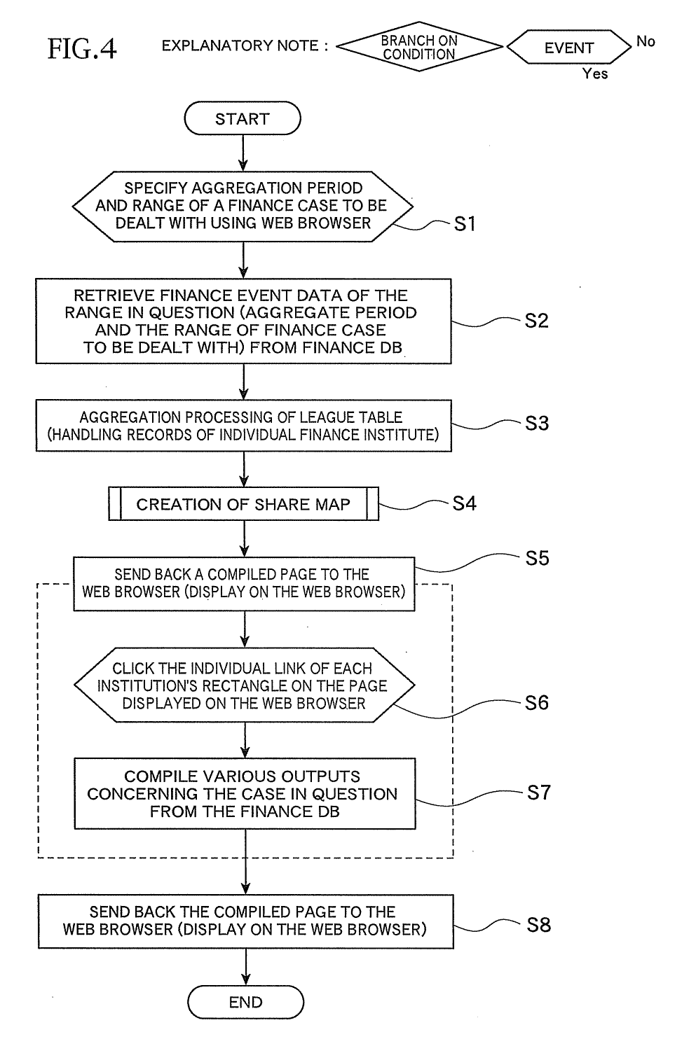

FIG. 4 is a flowchart showing a processing procedures of the share map display system of an embodiment of the present invention. The processing procedures of the share map display system will be explained in detail based on the flowchart.

A user of a client terminal 6 makes a front page (not shown) to be displayed on the Web browser 7 of the relevant client terminal 6, and then clicks a share map creation execution button after specifying a time period to be handled and a range of a financial investment to be aggregated (Step S1).

The display region forming section 14 of the share map display apparatus 1 accesses the finance database 3 and acquires finance event data corresponding to a command (including the time period to be handled and the range of the financial investment to be aggregated) which is input from the Web browser 7 (Step S2).

Next, the display region forming section 14 performs aggregation (adding up) processing of a league table based on the finance event data acquired from the finance database 3 (Step S3). This league table is a handling record of a financial product in a specific role of an individual financial institution. More precisely, as seen in the bond-related finance institution table 31b and the stock-related financial institution table 32b of FIGS. 2A and 2B and FIGS. 3A and 3B, the handling records of the specified role (for example, the lead manager plays this role, the lead manager is used as the specified role herein after) in the data corresponding to the finance event mentioned above are aggregated by each financial institution. That is, in this case, the handling records of the financial products which is to be aggregated according to a command from the client terminal 6 is regarded as the league table. The aggregated league table is sorted in the order of the magnitude of occupancy ratio of the handling records of an individual financial institution to the whole handling records.

When aggregation of the league table is completed, share map creation process is performed (Step S4).

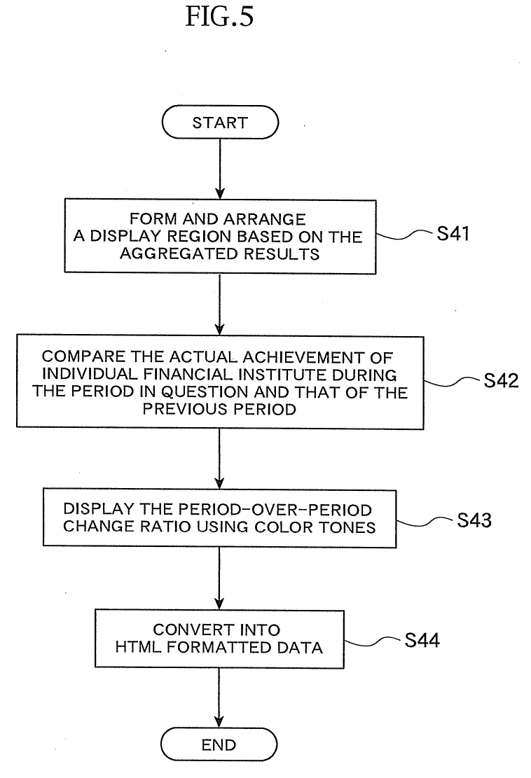

FIG. 5 is a flow chart showing a concrete procedures for creation of the share map. As shown in FIG. 5, the display region forming section 14 forms and arranges a rectangular display region having an area ratio which corresponds to an actual achievement share of an individual financial institution based on the aggregated results (Step S41). An actual achievement comparison and display section 15 compares an actual achievement share of an individual financial institution in the specific aggregation time period with an actual achievement share of an individual financial institution right before the specific aggregation time period (Step S42), and displays a rate of change by color tone on the display region formed by the display region forming section 14 (Step S43). The image data forming section 16 forms data of HTML format from the display region formed by the display region forming section 14 and the color tone formed by the actual achievement comparison display section 15 (Step S44). Hereinafter these procedures will be explained in more detail.

### <Forming and Arrangement of the Display Region>

At first, the display region forming section 14 forms and arranges the rectangular display region whose area ratio is represented by an actual achievement share of an individual financial institution based on the aggregated results (Step S41).

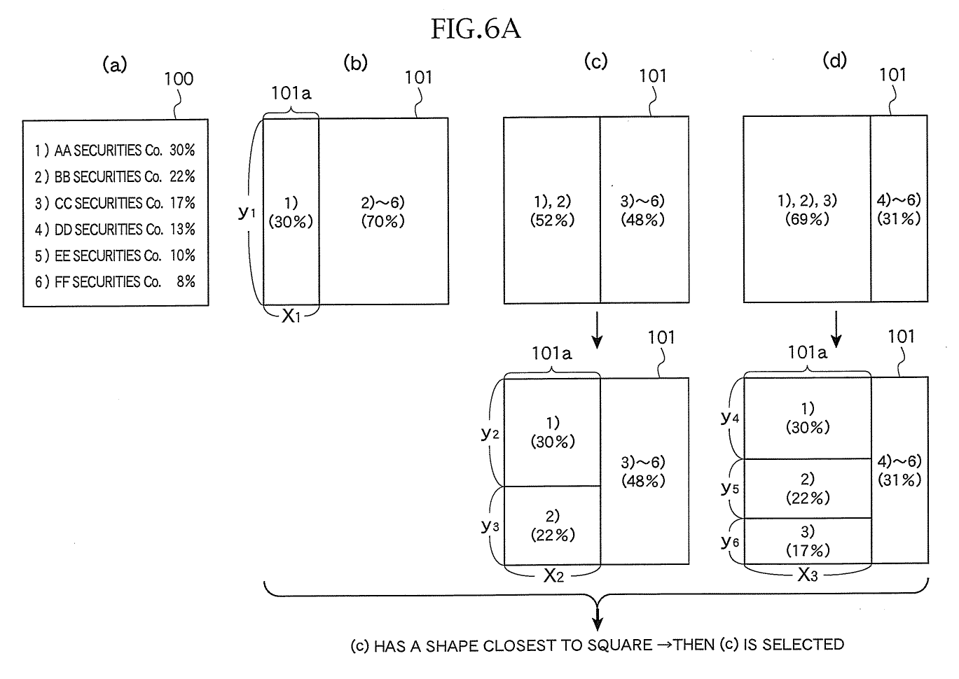

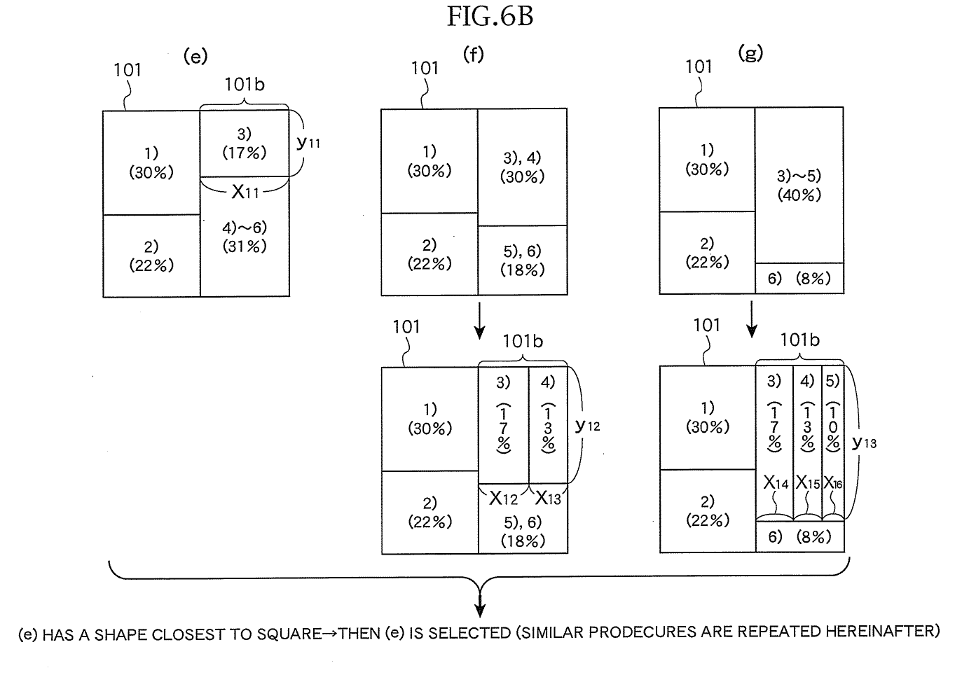

FIGS. 6A and 6B are schematic diagrams showing processing procedures of the display region forming section 14, in which the display region is formed and arranged at the step S41. As seen in FIGS. 6A and 6B, formation and arrangement of the display region of this embodiment are performed using a display region formation method by “squarification algorithm” (Bruls, M. Huizin g, K. van Wijk. J. J., Squarified treemaps, Proceeding of Joint Euro-graphics and IEEE TCVG Symbosium on Visualization, Amsterdam, the Netherlands, 29-30 May 2000. 33-42) and an arrangement of a plurality of the second display regions in the first display region and also an arrangement of a plurality of the third display regions in a specific second display region are performed such that the plurality of display regions having the same hierarchy are to be arranged from an upper left corner down to a lower right corner in the descending order of area (size) of display region. The procedures will be described in detail.

FIG. 6A is a diagram showing a table 100 which illustrates ratios of handling records of a specific financial product of 6 securities companies to the total handling records. Here, the handling records of 6 financial institutions (Here, securities companies) are AA securities (30%), BB securities (22%), CC securities (17%), DD securities (13%), EE securities (10%) and FF securities (8%). In the table 100, 6 securities companies are sorted and aligned in the descending order in terms of occupancy ratio of the handling records. The display region forming section 14 arranges information of these handling records in almost whole inside area of the second display region 101 (As described later, second display region represents the total amount of the handling records of a specific financial product of a specific field such as a “domestic public offering” or “government backed bond” etc.) and this whole area of the second display region is divided and used as the third display regions. When making arrangement of the third display region, the display region forming section 14 arranges them by repeatedly confirming horizontal to vertical ratio of the side based on two rules below: Rule 1: when there is a plurality of third display regions, much larger one is arranged at the upper left corner. Rule 2: when there are multiple ways of arrangement in arranging the plurality of third display regions, each third display region should be arranged such that every third display zone has a shape as close as possible to a square shape.

For example, when 6 third display regions shown in table 100 in FIG. 6A are arranged in the second display region 101 (FIGS. 6A, 6B), following procedures are performed.

(1-1) At first, the display region forming section 14 marks off an area which corresponds to a ratio (30%) of AA securities from the second display region 101 with a vertical straight line such that the marked-off area is located on the left side of the vertical straight line as shown in FIG. 6B. And, a horizontal side to a vertical side ratio x₁:y₁, of the left side region 101a is confirmed (b in FIG. 6A). A region where the horizontal side to the vertical side ratio x₁:y₁ is confirmed, is herein after referred to as “confirmed region”.

(1-2) Next, the display region forming section 14 marks off an area which corresponds to a ratio (52%) which is obtained by adding the ratios of AA securities and BB securities from the second display region 101 with a vertical straight line. The resulting confirmed region 101a formed at the left side of the vertical straight line is further marked off into 2 regions with the ratios of AA securities (30%) and BB securities (22%). Then horizontal sides to the vertical sides ratios x₂:y₂ and x₂:y₂ are confirmed (c in FIG. 6A).

(1-3) Next, the display region forming section 14 marks off an area which corresponds to a ratio (69%) which is obtained by adding the ratios of AA securities, BB securities and CC securities from the second display region 101 with a vertical straight line. The resulting confirmed region 101a formed at the left side of the vertical straight line is further marked off into 3 regions with the ratios of AA securities (30%), BB securities (22%) and CC securities (17%). Then the horizontal sides to the vertical sides ratios x₃:y₄, x₃:y₅ and x₃:y₆ are confirmed (d in FIG. 6A).

When the horizontal to vertical sides ratios x₂:y₂ and x₂:y₃ of the procedure (1-2) (c in FIG. 6A) is found to form a shape most closer to a square among the confirmed regions 101a formed in every cases as a result of the procedures (1-1) to (1-3), AA securities' third display region and BB securities' third display region are selected to be arranged inside the second display region 101 in the form of (1-2) arrangement (c in FIG. 6A).

Next, as shown in FIG. 6B, a confirmed region 101b is formed in the rest of the second display region 101. As shown in e to g in FIG. 6B, arrangement and demarcation of the third display region of remaining CC securities and DD securities are determined in the similar procedures as shown in (1-1) to (1-3) mentioned above. That is, following processing is performed.

(2-1) At first, an area which corresponds to a ratio (17%) of CC securities with respect to the total ratio (48%) of CC securities company to GG securities is marked off from the confirmed region 101b with the horizontal straight line. A ratio of a horizontal side to a vertical side x₁₁:y₁₁ of the region formed at an upper side of the horizontal straight line is confirmed (e in FIG. 6B).

(2-2) Next an area which corresponds to a ratio (30%) which is obtained by adding the area of CC securities and DD securities with respect to the total ratio (48%) of CC securities to GG securities is marked off from the confirmed region 101b with a horizontal straight line. Then area which corresponds to a ratio (17%) of CC securities company and a ratio (13%) of DD securities company are marked off from the upper region formed at the upper side of the horizontal straight line with a vertical straight line. Ratios of a horizontal side to a vertical side x₁₂:y₁₂, x₁₃:y₁₂ of the 2 regions are confirmed (f in FIG. 6B).

(2-3) Next, an area which corresponds to a ratio (40%) which is obtained by adding the area of CC securities, DD securities and EE securities with respect to the total ratio (48%) of CC securities to GG securities is marked off from the confirmed region 101b with a horizontal straight line. Then area which corresponds to the ratio (17%) of CC securities, the ratio (13%) of DD securities and the ratio (10%) of EE securities are marked off into 3 regions from the upper region formed at the upper side of the horizontal straight line with vertical straight lines. Ratios of a horizontal side to a vertical side x₁₄:y₁₃, x₁₅:y₁₃, x₁₆:y₁₃ of the 3 regions are confirmed (g in FIG. 6B).

The display region forming section 14 compares the ratios of the horizontal side length to the vertical side length which are formed in the above mentioned procedures (2-1) to (2-3) and then selects (2-1) which has a shape closest to a square shape (e in FIG. 6B).

Such arrangements shown in (1-1) to (2-3) mentioned above are repeatedly performed and the inner side of the second display region 101 is divided into a plurality of the third display regions which are each made into a shape as close as possible to a square shape and are arranged in the descending order of area from the upper left corner down to the lower right corner.

In addition, the display region forming section 14 arranges a plurality of second display regions in an almost whole region of the first display region having a certain shape based on the procedures shown in (1-1) to (2-3) mentioned above. The plurality of second display regions each has a shape as close as possible to a square shape and are arranged in descending order of area from the upper left corner down to the lower right corner.

Thus, the second display regions are arranged inside almost whole region of the first display region in descending order of area from an upper left corner down to a lower right corner. And a plurality of the third display regions are arranged inside the second display region in descending order of area from an upper left corner down to a lower right corner.

According to these procedures, the second and third display regions can be surely and easily made each into a shape as close as possible to a square shape and arranged in the descending order of area from an upper left corner down to a lower right corner using computer algorithm.

### <Color Display>

Next, the handling records comparison and display section 15 compares an actual achievement share of handling record of each financial institution for a specific aggregation period (period in question) with the handling records of each financial institution for the period right before the aggregation period (previous period) (Step S42). The resulting rate of a change (period-over-period-basis) is represented by color (color and its density) on the third display region formed by the display region forming section 14 (Step S43).

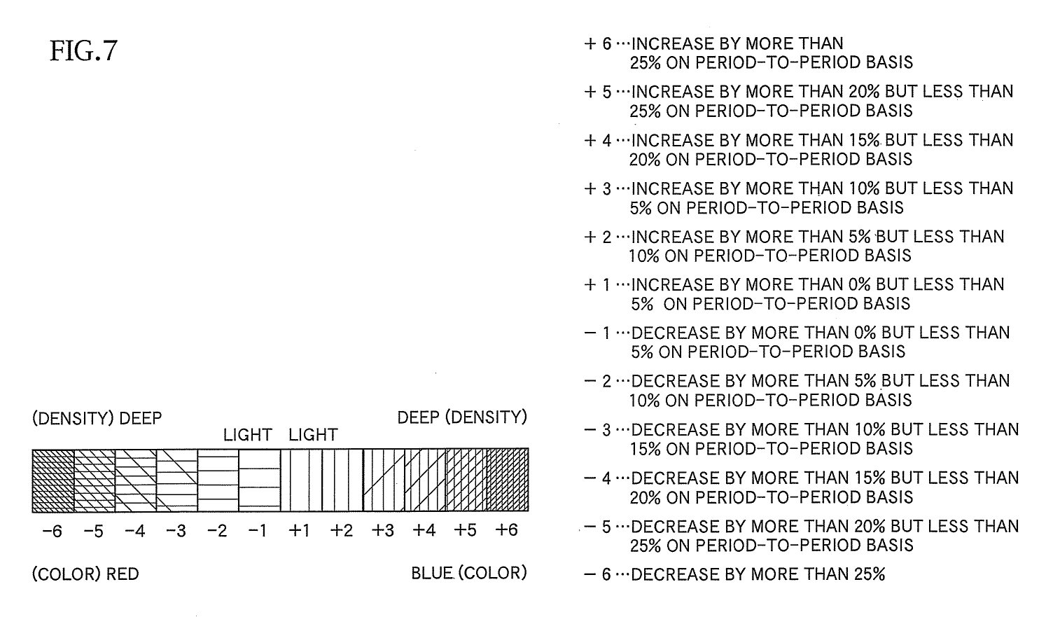

FIG. 7 is a schematic diagram showing a processing performed by the handling records comparison and display section 15 to decide the color to be applied on the third display region. As shown in FIG. 7, the handling record comparison and display section 15 calculates the period-over-period percentage changes by comparing the actual achievement share of the handling records for each of the financial institutions, which are displayed on the third display regions, between the period in question and the previous period. The calculated period-over-period percentage changes are displayed on each third display region as displayed in the same manner as shown in FIG. 7. That is, the period-over-period percentage changes are classified into different grades at a prescribed-ratio intervals, and different colors are applied on each classified area of the third display region. The period-over-period percentage changes are classified into 12 grades of every 5% change. Increase (+) in the percentage change is represented by blue color and decrease (−) is represented by red color, and the larger the absolute value of a numerical value, the deeper in color. As seen in a figure attached to this specification, color tone is for convenience, represented by a direction and a density of straight lines in a schematic way. Specifically, a horizontal line and a combination of the horizontal line and a diagonal line represent a red color and a vertical line and a combination of the vertical line and the diagonal line represents a blue color. A pitch of the lines represents the color density.

Thus, different color tones are displayed on each third display region based on the period-over-period percentage change of each financial institution. In the present embodiment, blue and red colors are used for the third display regions, however colors can be used for the second display regions. Colors other than red and blue may be used.

### <Formation of HTML Data>

The image data forming section 16 converts the display region formed by the display region forming section 14 and the color tones formed by the handling records comparison and display section 15 into data formatted with HTML (Step S44).

In other words, data regarding an area (size) or an arrangement of the first, the second and the third display region and data regarding the color tones applied on each third display region are described between <DIV> and </DIV> of the body portion of HTML. Specifically, information on a position and size of a rectangle is defined by a style attribute of a DIV tag (Hereafter, explanation of this attribute will be described. This attribute meets the CSS specifications (Cascading Style Sheets, level 1-W3C Recommendation 17 Dec. 1996, revised 11 Jan. 1999 and Cascading Style Sheets, Level 2 CSS2 Specification-W3C Recommendation 12 May 1988)).

More precisely, a positional (such as top and left) property and size (such as width and height) property are set by the value calculated above. Concerning the color tone, background-color-related property is set as a color specification value specified by RGB format color tone based on the calculation results mentioned above. In the above mentioned algorithm, the rectangular shape is drawn “within” the upper classified rectangular shape (for example, the third display regions of a specific securities company is drawn within the second display region 101). The outer rectangle is calculated prior to the calculation of the inner rectangle. In order to ensure that the inner side rectangle is surely drawn in front of the outer rectangle, a number that shows a hierarchy which is now computed is set to z-index property. According to the CSS specification, HTML element having greater z-index is surely drawn in front of the HTML element having smaller z-index. Therefore, for example, the rectangle of the third display region is drawn on top of the rectangle of the second display region. On the other hand, various texts in the rectangle are described as a text between <DIV> and </DIV> in the HTML format. Web browser draws these texts, based on the HTML specification, in the rectangle specified by the DIV tags. Thus, the share map in the HTML format can be formed.

As the first, second and third display regions are converted into a share map in the HTML format, the share map is created into an image data which is suitable for network communications and the contents of which can visually be grasped. The share map is sent to the client's terminal 6 and the share map can be displayed on the client's terminal 6 only using the Web browser 7. There is no need of using other application such as Java (Registered Trademark) applet etc. on the client's terminal 6 side, therefore mounting of software on the client's terminal 6 can be simplified and thus, security can be improved. In addition, processing in the Web browser 7 can be performed at a high speed and thereby, response time at the time of display can be shortened in the Web browser 7.

### <Display of Share Map>

The image data forming section 16 returns the share map in HTML format to the Web browser 7 as a web page and displays it on the Web browser 7 (Step S5). The share map displayed on the Web browser 7, as shown below, has a whole share map which displays the first, second and third display regions and a partial share map which displays a specific second display region and the third display region in the specific second display region.

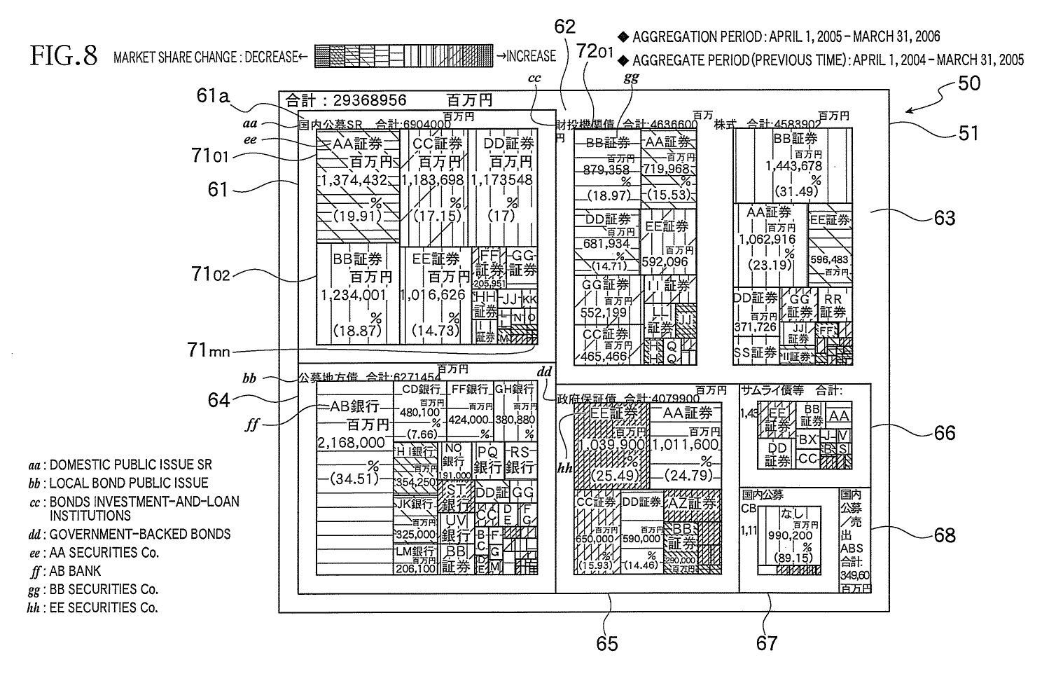

FIG. 8 is an image diagram showing a whole share map displayed on the Web browser 7 in Step S5. The whole share map 50 shown in FIG. 8 represents the aggregated results of “occupancy status of a lead manager of a domestic public offering”. As shown in FIG. 8, the aggregation period is set to 1 year. Occupancy status of the second and third display regions is determined based on the aggregated handling records during the time period in question (Apr. 1, 2005-Mar. 31, 2006). And color tones of the third display regions are determined by the period-over-period percentage changes based on the handling records of the time period in question and the previous period (Apr. 1, 2004-Mar. 31, 2005).

More specifically, in the whole share map 50, the whole inside region of the rectangular first display region 51 having a certain shape is divided by the second display regions 61, 62, . . . , 68 which is a lower hierarchy of the first display region 51. The whole inside region of each of the second display regions 61, 62, . . . 68 is divided by the third display region 71₀₁, 71₀₂, . . . 71ₘₙ, 72₀₁, . . . which is a lower hierarchy of the second display region. That is, the whole share map 50 forms a hierarchical structure. Therefore, the handling records such as transaction amount and the total transaction amount of a financial product of a specific field or handling records such as handling amount etc. of financial product of each individual company that handles a financial product of a specific field can be visually grasped as an area (size) of display region, which is formed with a repeated hierarchical structure. The second display region 61, 62, . . . 68, which is a lower hierarchy of the first display region 51, are arranged inside the first display region 51, and the third display region 71₀₁, 71₀₂, . . . 71ₘₙ, 72₀₁, . . . , which is a lower hierarchy of the second display regions 61, 62, . . . 68 are arranged inside the second display regions 61, 62, . . . 68.

Here, the first display region 51 represents a total amount of handling record as a lead manager of financial institutions in “domestic public offering”. The area (size) of the second display region 61, 62, . . . 68 represents a total amount of the handling records of a specific field (domestic public offering SB, public offering local bonds, bonds investment-and-loan institution, government-based bonds, corporate stock, yen-denominated foreign bonds, domestic public offering CB/BW, domestic public offering/offering ABS) in the “domestic public offering”. The area (size) of the third display regions 71₀₁, 71₀₂, . . . 71ₘₙ, 72₀₁, . . . represents handling records of each financial institution in each specific field, which is a detailed field of each specific field shown in the second display region 61, 62, . . . 68.

The area (size) of the second display regions 61, 62, . . . 68 is determined based on the information on the total amount of the handling records of the financial products in a specific field. Therefore, ranking and occupancy status etc. of each financial product (for example, domestic public offering SB, public offering local bonds, government-backed bonds etc. which forms an issue amount of domestic public offerings) in the total amount (for example the issue amount of domestic public offerings) of financial product of a specific field, can visually be grasped easily. In addition, each area (size) of the third display regions 71₀₁, 71₀₂, . . . 71ₘₙ, 72₀₁, . . . is determined based on the information on the handling records of financial products in a special field of each company that handles individual financial products. Therefore, ranking and occupancy status in the market of the handling records of financial products of the company or handling records of each company's financial products in a specific financial and capital market, can visually be grasped easily.

Information on the handling records which are illustrated in each of the third display regions 71₀₁, 71₀₂, . . . 71ₘₙ, 72₀₁, . . . is an issue amount of the financial products which are handled by a company that handles financial products as a lead manager. These kinds of information can be effectively used in such a way that can be visually grasped as specifically important information which is used in making decision for the investors at the time they open their accounts or for the people who selects a securities company or financial institution as a lead manager at the time they offer stocks or bonds to the public.

In the first display region 51, the second display regions 61, 62, . . . , 68 and the third display regions 71₀₁, 71₀₂, . . . , 71ₘₙ 72₀₁, . . . , information such as total amount, handling records and occupancy ratios etc. shown in each display region, are displayed as characters representing names of field and financial institution or as numerical characters representing the amount of money or ratios. The numerical values with symbol of % shown in the third display regions 71₀₁, 71₀₂, . . . , 71ₘₙ, 72₀₁, . . . indicates an occupancy ratio of each third display region (for example, the third display regions 71₀₁, 71₀₂, . . . 71ₘₙ) of one of the second display region (for example, the second display region 61). According to such display system, the contents of each display region can be visually grasped.

The second display regions 61, 62, . . . , 68 inside the first display region 51 are generally arranged in the descending order of area from an upper left corner down to a lower right corner. In addition, the third display regions 71₀₁, 71₀₂, . . . , 71ₘₙ, 72₀₁, . . . inside each second display regions 61, 62, 63, . . . are generally arranged in the descending order of area from an upper left corner down to a lower right corner. Accordingly, ranking of the area (size) within the second display regions 61, 62, . . . , 68 or the third display regions 71₀₁, 71₀₂, . . . , 71ₘₙ, 72₀₁, . . . inside one of the second display regions 61, 62, . . . , 68 or magnitude of the occupancy ratio with respect to the total can be visually grasped easily. Thus, the handling records of the financial products and occupancy status in the market can visually be grasped and easily interpreted.

In addition, the second display regions 61, 62, . . . , 68 and the third display regions 71₀₁, 71₀₂, . . . , 71ₘₙ, 72₀₁, . . . are arranged in such a way that they have a shape as close as possible to a square shape. Accordingly, the characters displayed in the second display regions 61, 62, . . . , 68, and the third display regions 71₀₁, 71₀₂, . . . , 71ₘₙ, 72₀₁, . . . would be legible and clearly displayed. The contents of information shown in each display region can be clearly displayed by characters so that the information on concrete contents such as handling records of financial products of a company etc. can much visually be grasped and much easier to be interpreted.

On each of the third display regions 71₀₁, 71₀₂, . . . , 71ₘₙ, 72₀₁, . . . , a color tone representing a period-over-period change ratio of a financial institution of the display region in question is applied. As shown in FIG. 8, on the third display regions 71₀₁, 71₀₂, . . . , 71ₘₙ, 72₀₁, . . . of the whole share map 50, color tones are schematically represented by directions and density of lines. Horizontal lines and the combination of the horizontal lines and oblique lines represent red, and vertical lines and the combination of vertical lines and oblique lines represent blue. Density of the lines represents density of the colors tones (FIG. 6).

The period-over-period change ratio is displayed on each third display region 71₀₁, 71₀₂, . . . , 71ₘₙ, 72₀₁, . . . so that the change in the handling records of a specific company can be grasped from the individual third display region 71₀₁, 71₀₂, . . . , 71ₘₙ, 72₀₁, . . . . Therefore, in addition to the relative relationship between individual information attached to each third display region 71₀₁, 71₀₂, . . . , 71ₘₙ, 72₀₁, . . . , magnitude and direction of the change with time in the information displayed on the individual third display region 71₀₁, 71₀₂, . . . 71ₘₙ, 72₀₁, . . . can be grasped. In addition, the period-over-period change ratio is displayed on the third display regions 71₀₁, 71₀₂, . . . 71ₘₙ, 72₀₁, . . . , with color tones (color and density of the color), magnitude and direction of the change with time in the information displayed on a specific third display region 71₀₁, 71₀₂, . . . , 71ₘₙ, 72₀₁, . . . , can visually be grasped and easily interpreted.

When a portion in which a name of a specific field is indicated at an upper left position of the second display regions 61, 62, . . . 68 is clicked, a partial share map which is an enlarged image of the clicked second display regions 61, 62, . . . 68 is displayed on the Web browser 7.

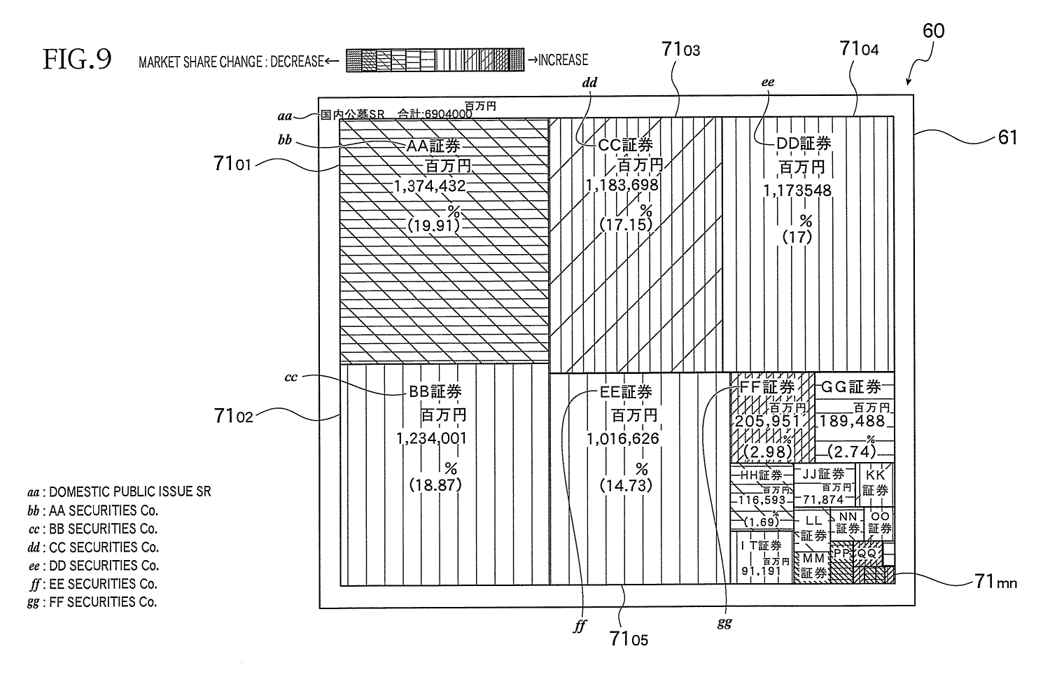

An image diagram of the partial share map 60 is shown in FIG. 9. FIG. 9 appears when the character 61a, “domestic public offering SB” representing the field of the second display regions 61 shown at the upper left corner in FIG. 8 is clicked. As shown in FIG. 9, the partial share map 60 is an enlarged image of the second display region 61 in FIG. 8. And the third display regions 71₀₁, 71₀₂, . . . , 71ₘₙ are displayed in almost whole region of the second display region 61. In the third regions 71₀₁, 71₀₂, . . . , 71ₘₙ of the partial share map 60 in FIG. 9, the color tones are represented by the direction and the density of the lines in the same way as shown in the whole share map 50 shown in FIG. 8. The third display regions 71₀₁, 71₀₂, . . . , 71ₘₙ in a specific second display region 61 can be displayed through the partial share map 60 so that the handling records of each individual company that handles financial products of a specific field can easily be seen and the handling records in question can easily be grasped.

When a user clicks a specific third display region (for example, the third display region 71₀₁, herein after explanation will be made on the condition that the third display region 71₀₁ is clicked) of the whole share map 50 displayed on the Web browser 7 or the partial share map 60, an individual link retrieval panel (not shown) for retrieving a precise information illustrating handling records of a financial institution on the third display region 71₀₁ in question, is displayed. In the individual link retrieval panel (not shown), several kinds of precise information selection button (not shown) are displayed. When the user clicks any one of the selection buttons (not shown) (Step S6), the event acquiring section 17 acquires the button-selected event from a finance database 3, compiles them (Step S7), returns the compiled page to the Web browser 7 as a Web page and displays it on the Web browser 7 (Step S8).

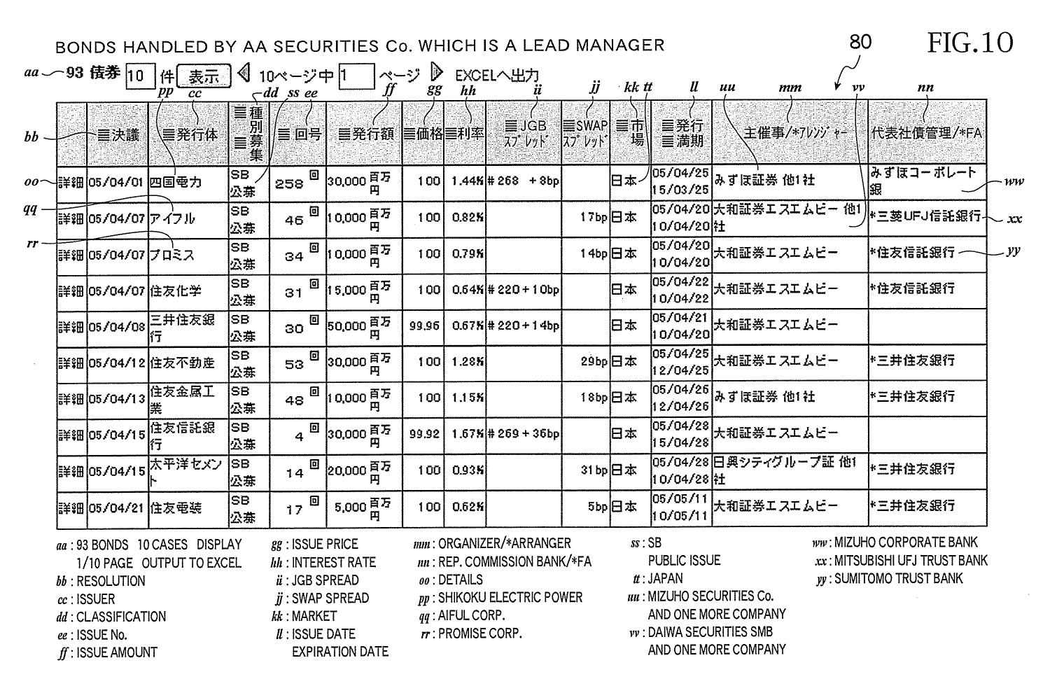

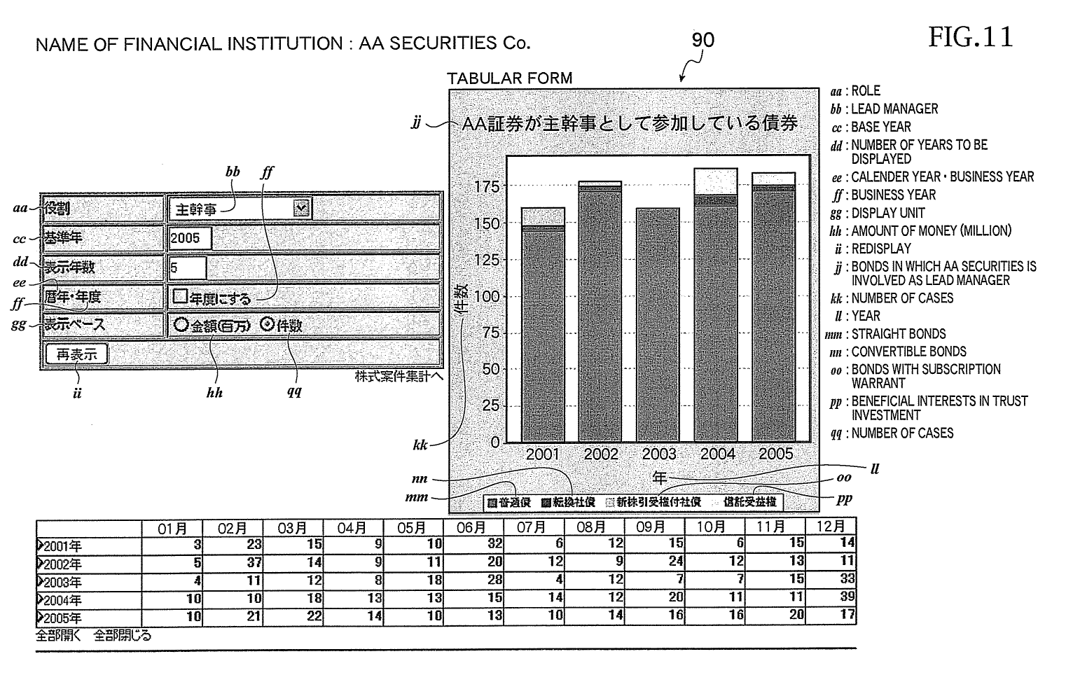

An image diagram of an itemized-and-detailed information-display page as a retrieval result page is shown in FIG. 10, and an image diagram of a detailed financial-institution information display page is shown in FIG. 11 as a retrieval result page respectively.

The itemized-and-detailed information-display page 80 and the detailed financial institution information display page 90 in FIGS. 10 and 11 are displayed on the Web browser 7 based on an operation of the individual link retrieval panel (not shown) which appears when the third display region 71₀₁ in FIG. 8 or 9 is clicked. In the itemized and detailed information-display page 80, detailed information (resolution date, issuer, classification, way of offering, issuance number, amount of issue etc.) of a specific handling records shown in the third displaying region 71₀₁ (Here in this case, AA securities represent bonds of a lead manager) is displayed. In the detailed financial institution information display page 90, a graph and/or table which shows the number of cases of bonds in which AA securities company participates as a lead manager for the last 5 years is/are displayed. These kinds of information are displayed on the Web browser 7 so that the user can, in detail and from various angles, acquire handling records of the financial institution displayed on the third display region 71₀₁.

As described above, the share map display system 1A of this embodiment has a function to form information related to the handling records of financial products and its occupancy status in the market into an image data in which contents can visually be grasped. And the image data are displayed on a computer interface (a Web browser 7 which is displayed on the display section 5 of the client's terminal 6), and information useful for the investors etc. can be provided.

In the above described embodiment, the present invention is applied to a share map display system 1A in which 3 hierarchies—the first display region 51, the second display regions 61, 62, 63, 64, 65, 66, 67, 68, the third display regions 71₀₁, 71₀₂, . . . , 71ₘₙ, 72₀₁, . . . , are formed, but the present invention is not limited to this embodiment. The present invention can be applied to a share map display system which has a hierarchical structure having more than fourth display region in the third display region. In such cases, regions more than four hierarchy can be formed and arranged, and display of color tones can also be applied according to the present invention.

In the above-described embodiment, information on the handling records is regarded as an issue amount of financial products which is handled by a company that handles financial products as a lead manager, but the present invention is not limited to the information on the issue amount of financial products. The present invention can be applied to information on other handling records of a company that handles financial products. More specifically, the present invention can be applied to information on the handling records of a lead manager or underwriter, information on handling records of a commission bank or information on the handling records of MA, coordination of MA, share allotment, finance/capital transaction such as loan and investment, securitization etc.

In the embodiment mentioned above, the display region forming section 14 is designed to acquire data when necessary from the finance data server 3 at Step S2, but once acquired data can be cached in the share map display apparatus 1 and can preferentially be used it for a next processing.

In the above described embodiment, the share map display apparatus 1 is embodied as a server-side computer, but it can be formed as a client-side computer or a stand-alone computer.

The embodiment described above is used for illustrative purpose only. Therefore it is noted that present invention is not limited to the embodiment described above.

### DESCRIPTION OF REFERENCES

| | |
|---|---|
| 1A | Share map display system |
| 1 | Share map display apparatus |
| 3 | Finance database server (database) |
| 5 | Display section (display means) |
| 6 | Client's terminal (terminal) |
| 14 | Display region forming section |
| | (display region forming means) |
| 15 | Actual achievement comparison |
| | display section |
| | (actual achievement comparison and |
| | display means) |
| 16 | Image data forming section (Image |
| | data forming means) |
| 50 | Whole share map (share map) |
| 51 | First display region |
| 60 | Partial share map (share map) |
| 61, 62, 63, | Second display regions |
| 64, 65, 66, 67, 68 | |
| 71₀₁, 71₀₂, . . . 71ₘₙ, | Third display regions |
| 72₀₁, . . . | |

1. A share map display apparatus which displays on displaying means of a terminal, an information on an occupancy status of a company such as a financial institution which deals with financial products in a financial capital market, has a display region forming means which forms:
a first display region having a certain shape and indicating a total amount of handling records of a specific financial product;
a plurality of second display regions each having a rectangular shape, an area of which is determined based on an information on the handling records of the specific financial product in a specific field, a whole area of the first display region is divided into the plurality of second display regions, and
a plurality of third display regions each having a rectangular shape, an area of which is determined based on each handling record that constitutes the specific field, a whole area of the second display regions is divided into the plurality of third display regions,
wherein the display region forming means forms at least 3 hierarchically-structured display region groups, the second display region is a lower hierarchy of the first display region which is divided into the plurality of second display regions, the third display region is a lower hierarchy of the second display region which is divided into the plurality of third display regions, and the display region forming means arranges the plurality of second display regions inside the first display region and the plurality of third display regions inside the second display region in descending order of area from an upper left corner down to a lower right corner, respectively.

2. A share map display apparatus according to claim 1, wherein the share map display apparatus further has image data forming means for converting the display region groups into data of HTML format and sending the data of HTML format to the display means of the terminal.

3. A share map display apparatus according to claim 1, wherein the display region forming means arranges the second display region and the third display region into a shape as close as possible to a square shape.

4. A share map display apparatus according to claim 3, wherein the display region forming means repeatedly rearranges all of the second display regions inside the first display region so that the arranged second display region has a shape as close as possible to a square shape by:
at first, calculating a ratio of each area to a total area of the second display regions;
based on the calculated ratio, marking off an area at an upper left portion of the first display region, which is not yet occupied by anyone of the second display regions, in proportion to the ratio of one or a plurality of the second display regions having the largest area/larger areas out of all second display regions by either vertical or horizontal straight line; and then marking off an inside, which is already marked off, of the first display region in proportion to the ratio of one or a plurality of the second display regions by either vertical or horizontal straight line.

5. A share map display apparatus according to claim 3, wherein the display region forming means repeatedly rearranges all of the third display regions inside the second display region so that the arranged third display region has a shape as close as possible to a square shape by:
at first, calculating a ratio of each area to a total area of the third display regions;
based on the calculated ratio, marking off an area at an upper left portion of the second display region, which is not yet occupied by any one of the third display regions, in proportion to the ratio of one or a plurality of the third display regions having the largest area/larger areas out of all of the third display regions by either vertical or horizontal straight line; and then marking off an inside, which is already marked off, of the second display region in proportion to the ratio of one or a plurality of the third display regions by either vertical or horizontal straight line.

6. A share map display apparatus according to claim 1, wherein the display region forming means determines the area of an individual third display region based on the handling records of a financial product in the specific field of a company that handles individual financial product.

7. A share map display apparatus according to claim 1, wherein the display region forming means determines the area of the second display region based on the information on the total amount of the handling records of the financial product in the specific field.

8. A share map display apparatus according to claim 1, wherein the share map display apparatus further has record comparison display means that performs following steps:
aggregating information on the handling records for every prescribed time period;
comparing information on the handling records for a specific time period with the information on the handling record for the period right before the specific time period; and
displaying a change in the information on the handling records calculated by the comparison on the third display region.

9. A share map display apparatus according to claim 8, wherein the record comparison display means displays the change in the information on the handling records by color and density of the color on the third display region.

10. A share map display apparatus according to claim 1, wherein the information on the handling records is an information on an issued amount of a financial product handled by a company that handles the financial product as a lead manager.

11. A share map display system, which comprises:
a share map display apparatus according to claim 1; and
a database for storing data, including information on the handling records of a specific financial product, of a finance event, an act at a specific time point for changing funds or capital of an organization such as a firm.

12. A program for making a computer function as a share map display apparatus according to claim 1.
